(19) United States
(12) Patent Application Publication
(10) Pub. No.: US 2013/0297648 A1
(43) Pub. Date: Nov. 7, 2013

(54) SERVER, TERMINAL DEVICE, IMAGE SEARCH METHOD, IMAGE PROCESSING METHOD, AND PROGRAM

(71) Applicant: Panasonic Corporation, Osaka (JP)

(72) Inventors: Koichi HOTTA, Hyogo (JP); Katsuyuki MORITA, Osaka (JP); Eiji FUKUMIYA, Osaka (JP)

(21) Appl. No.: 13/935,322

(22) Filed: Jul. 3, 2013

Related U.S. Application Data
(63) Continuation of application No. PCT/JP2012/003902, filed on Jun. 14, 2012.

(30) Foreign Application Priority Data
Feb. 2, 2012 (JP) 2012-020576

(51) Int. Cl. G06F 17/30

(52) U.S. Cl. CPC G06F 17/30277
USPC 707/769

(57) ABSTRACT

A server is provided which can easily search for an image showing a desired search object in a database containing an imaging location and image data in an associated manner. The server searches for an image in a database containing image capture location information indicating an image capture location and an image captured at the image capture location in an associated manner. The server includes: an information obtainment unit that obtains object location information indicating a location of a search object; and a search unit that searches images contained in the database for at least one image showing the search object, based on the object location information obtained by the information obtainment unit and the image capture location information contained in the database.

### CROSS REFERENCE TO RELATED APPLICATIONS

This is a continuation application of PCT International Application No. PCT/JP2012/003902 filed on Jun. 14, 2012, designating the United States of America, which is based on and claims priority of Japanese Patent Application No. 2012-020576 filed on Feb. 2, 2012. The entire disclosures of the above-identified applications, including the specifications, drawings and claims are incorporated herein by reference in their entirety.

### FIELD

The present disclosure relates to servers, terminal devices, image search methods, image processing methods, and programs for searching for a desired image in a database containing an image capture location and an image in an associated manner.

### BACKGROUND

In recent years, systems that provide a map and an image captured from a location on the map in an associated manner have been realized, and various techniques have been developed.

For example, Patent Literature 1 discloses a map display system for displaying a picture on a map when a user specifies a path (road) on the map. In the picture, a building adjacent to the path is captured from the side of the path.

### CITATION LIST

### Patent Literature

[PTL 1] Japanese Unexamined Patent Application Publication No. 2006-72068

### SUMMARY

### Technical Problem

A conventional image database associated with location information on image capture locations is suitable for specifying an image capture location and searching for an image of the surrounding area. However, it is unsuitable for specifying a search object and searching for an image showing the search object.

Therefore, an object of the present disclosure is to provide a server and others in which an image showing a desired search object can be easily searched for from a database containing an image capture location and image data in an associated manner.

### Solution to Problem

To achieve the object, a server according to an aspect of the present disclosure is a server for searching for an image in a database containing image capture location information indicating an image capture location and an image captured at the image capture location in an associated manner. The server includes: an information obtainment unit that obtains object location information indicating a location of a search object; and a search unit that searches images contained in the database for at least one image including the search object, based on the object location information obtained by the information obtainment unit and the image capture location information contained in the database.

According to this configuration, the search unit searches the images contained in the database for at least one image showing the search object, based on the object location information obtained by the information obtainment unit and the image capture location information. Therefore, a user can obtain an image showing the search object only by specifying the search object, for example.

It should be noted that these general and specific aspects may be implemented using a method, a program, a recording medium, or an integrated circuit, or any combination of methods, programs, recording media, or integrated circuits.

### Advantageous Effects

According to a server of the present disclosure, even when a database in which an image and an image capture location are associated is used as an image database, an image showing a desired search object can be easily searched for.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram illustrating a configuration of an image search system including a server according to the first embodiment.

FIG. 2 is a schematic view of an example of a map illustrating positional relationships between image capture locations and search objects.

FIG. 3 is a schematic view illustrating a configuration of data contained in a database.

FIG. 4 illustrates an example of an omnidirectional image represented by image data contained in an image file.

FIG. 5 is a schematic view illustrating a configuration of object information used by a server according to the first embodiment.

FIG. 6 is a schematic view illustrating the boundary of a portion to be clipped from an omnidirectional image.

FIG. 7 is a flowchart illustrating the steps of image search processing according to the first embodiment.

FIG. 8 is a schematic view illustrating a configuration of object information used by a server according to the second embodiment.

FIG. 9 is a block diagram illustrating a configuration of an image search system including a server according to the third embodiment.

FIG. 10 is a flowchart illustrating the steps of image search processing according to the third embodiment.

FIG. 11 is a block diagram illustrating a configuration of an image search system including a server according to the fourth embodiment.

FIG. 12 is a schematic view illustrating a configuration of object information used by a server according to the fourth embodiment.

FIG. 13 is an example of an image showing a search object X.

FIG. 14 is a flowchart illustrating the steps of image search processing according to the fourth embodiment.

FIG. 15 is a block diagram illustrating a configuration of an image search system including a terminal computer according to the fifth embodiment.

FIG. 16 is a flowchart illustrating the steps of image search processing according to the fifth embodiment.

FIG. 17 is a block diagram illustrating a configuration of a program activated by a terminal computer according to the first modification.

### DESCRIPTION OF EMBODIMENTS

### (Underlying Knowledge Forming Basis of the Present Disclosure)

The inventors found that the following problem is caused in the server recited in the “Background section”.

In the technique recited in PTL1, when a user tries to find an image showing a search object, the user herself or himself has to guess that if which location the user specifies, the user can obtain an image showing the search object, and specify the image capture location before image search. When trying to obtain, in this way, an image showing a desired search object using an image database associated with location information on the image capture location, the user cannot directly search for the image and has to specify the image capture location where the desired search object was captured before image search. This is a complex procedure for users.

To solve such a problem, a server according to an aspect of the present disclosure is a server for searching for an image in a database containing image capture location information indicating an image capture location and an image captured at the image capture location in an associated manner. The server includes: an information obtainment unit that obtains object location information indicating a location of a search object; and a search unit that searches images contained in the database for at least one image including the search object, based on the object location information obtained by the information obtainment unit and the image capture location information contained in the database.

According to the above configuration, the search unit searches the images contained in the database for at least one image showing the search object, based on the object location information obtained by the information obtainment unit and the image capture location information. Therefore, a user can obtain an image showing the search object only by specifying the search object, for example.

Moreover, for example, the server may further include a reception unit that receives identification information for identifying the search object; and a storage unit that prestores object information in which the identification information and the object location information are associated, in which the information obtainment unit may obtain the object location information from the object information stored in the storage unit, based on the identification information received by the reception unit, the object location information indicating the location of the search object identified by the identification information.

According to the above configuration, the object information in which the identification information for identifying the search object and the object location information are associated is prestored in the storage unit. Since the detailed information on the search object is prestored in the server, the user can obtain an image showing a desired search object only by transmitting to the server the identification information for identifying the search object.

Moreover, for example, the search unit may search images contained in the database for at least one image associated with image capture location information indicating a location in an area within a predetermined distance from the location of the search object, based on the object location information obtained by the information obtainment unit and the image capture location information contained in the database.

According to the above configuration, the search unit searches the images contained in the database for at least one image associated with the image capture location information indicating a location within a predetermined distance. Therefore, since image search is performed after narrowing down images, processing burden of the server required for the image search can be reduced.

Moreover, for example, the information obtainment unit may further obtain directional information indicating a predetermined direction from the location of the search object toward a location in which a predetermined image of the search object can be viewed, and the search unit may search images contained in the database for at least one image associated with image capture location information indicating a location in a predetermined direction from the location of the search object, based on the directional information obtained by the information obtainment unit and the image capture location information contained in the database, the predetermined direction being indicated by the directional information.

According to the above configuration, the search unit searches images contained in the database for at least one image associated with the image capture location information indicating a location in a predetermined direction from a search object that is indicated by the directional information, based on the directional information indicating the predetermined direction and the image capture location information. Therefore, since image search is performed after narrowing down images based on the directional information, processing burden of the server required for the image search can be reduced.

Moreover, for example, the information obtainment unit may further obtain a reference image showing an image of a portion of the search object, and the server may further include a determination unit that determines whether or not the image searched for by the search unit includes the reference image, based on the reference image obtained by the information obtainment unit.

According to the above configuration, the determination unit determines whether or not the reference image is included in an image obtained as result of search by the search unit, based on the reference image obtained by the information obtainment unit. Therefore, an image showing a good image of the search object can be easily obtained.

Moreover, for example, the server may further include a direction identifying unit that identifies an object direction in which the search object appears in the image searched for by the search unit; and an image clipping unit that clips a portion including the object direction from the image based on the object direction identified by the direction identifying unit.

According to the above configuration, the image clipping unit clips a portion of the image obtained as a result of search by the search unit, based on the object direction in which the object appears. Here, the portion of the image includes the object direction identified by the direction identifying unit. Therefore, the user can obtain a clipped area corresponding to a predetermined area showing the search object in the image. In other words, it is possible to reduce burden of the user to find out a portion showing the search object from the searched image.

Moreover, for example, the direction identifying unit may identify a direction from the image capture location toward the location of the search object as the object direction, based on the object location information obtained by the information obtainment unit and the image capture location information.

According to the above configuration, the direction identifying unit identifies, as the object direction, the direction from the image capture location toward the location of the search object. Therefore, the direction to be clipped can be automatically identified.

It should be noted that these general and specific aspects may be implemented using a method, an integrated circuit, a computer program, or a computer-readable recording medium such as a CD-ROM, or any combination of methods, integrated circuits, computer programs, or recording media.

The following specifically describes a server, an image search method, an image processing method, and a program according to an aspect of the present disclosure with reference to the drawings.

Each of the exemplary embodiments described below shows a general or specific example. The numerical values, shapes, materials, structural elements, the arrangement and connection of the structural elements, steps, the processing order of the steps and so on shown in the following exemplary embodiments are mere examples, and therefore do not limit the scope of the present disclosure. Therefore, among the structural elements in the following exemplary embodiments, structural elements not recited in any one of the independent claims representing superordinate concept are described as arbitrary structural elements.

### Embodiment 1

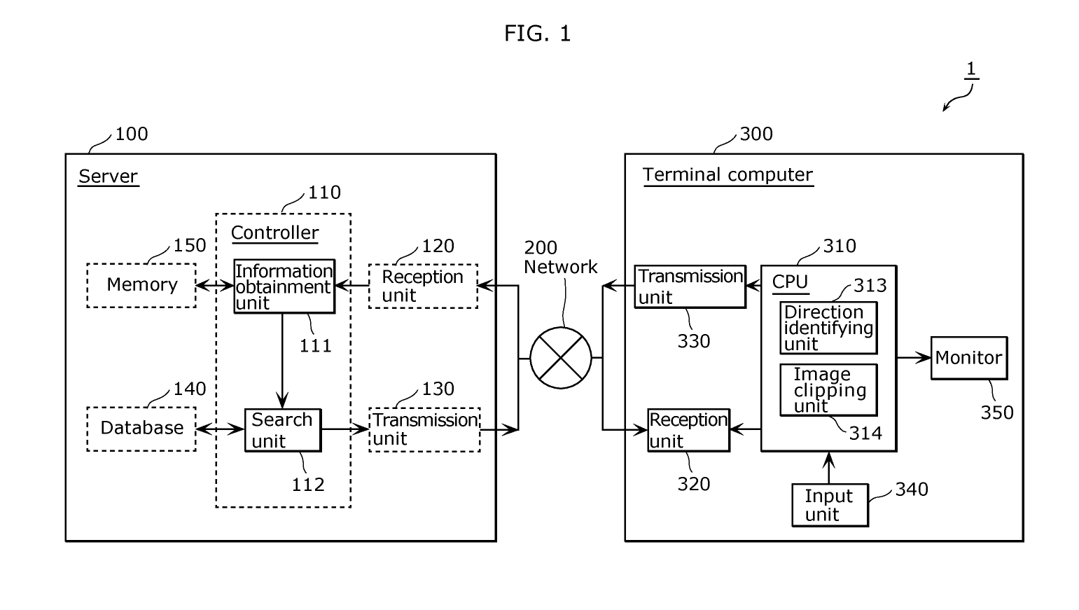

FIG. 1 is a block diagram illustrating a configuration of an image search system 1 including a server 100 according to the first embodiment. The image search system 1 includes the server 100, a network 200, and a terminal computer 300 as a terminal device. The server 100 and the terminal computer 300 are connected via the network 200.

The server 100 includes a controller 110, a reception unit 120, a transmission unit 130, a database 140, and a memory 150. Moreover, the controller 110 includes an information obtainment unit 111 and a search unit 112. The server 100 searches the database 140 for images. The database 140 contains, in an associated manner, image capture location information indicating an image capture location and an image captured at the image capture location.

The controller 110 controls the entirety of the server 100. The reception unit 120 receives data transmitted through the network 200.

The transmission unit 130 transmits data to an external device through the network 200.

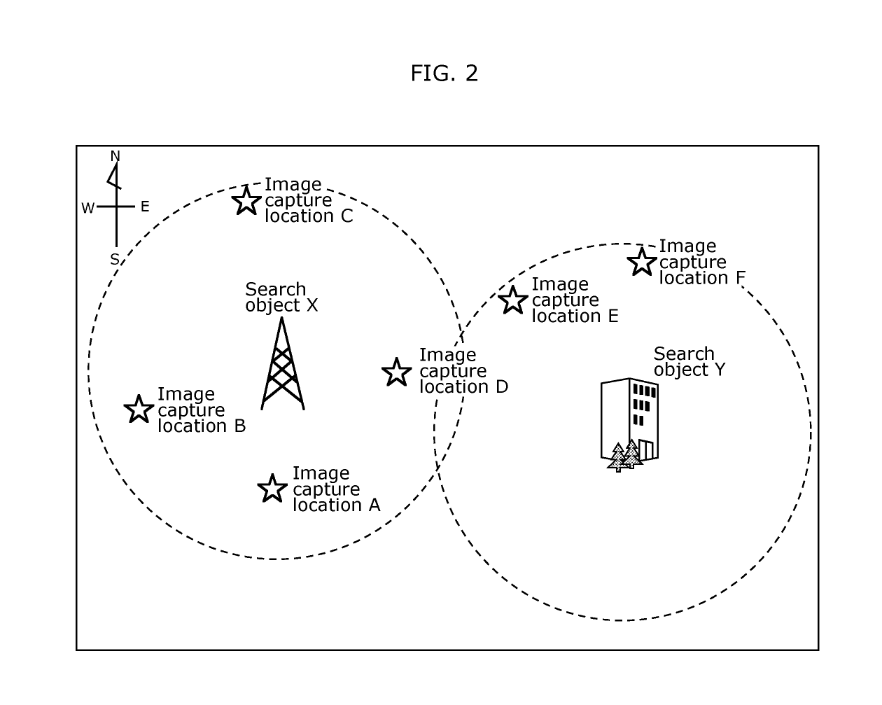

FIG. 2 is a schematic view of an example of a map illustrating positional relationships between image capture locations and search objects. As shown in FIG. 2, there are image capture locations A to D in the vicinity of a search object X (e.g., within a predetermined distance from the location of the search object X). The image capture location A is on the south side of the search object X. Moreover, with respect to the search object X, the image capture location B is on the west side, the image capture location C is on the north side, and the image capture location D is on the east side. Moreover, there is a search object Y located away from the search object X toward the east. There are image capture locations E and F in the vicinity of the search object Y (e.g., within a predetermined distance from the search object Y).

The information obtainment unit 111 obtains object location information indicating the location of a search object. The search unit 112 searches images contained in the database 140 for at least one image showing the search object, based on the object location information obtained by the information obtainment unit 111 and the image capture location information contained in the database 140.

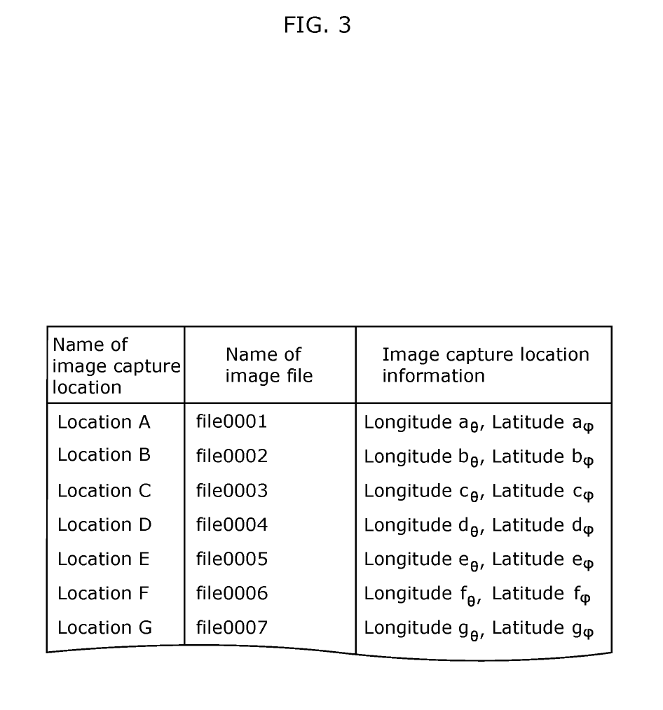

FIG. 3 is a schematic view illustrating a configuration of data contained in the database 140. In the data, an image capture location and an image captured at the image capture location are associated. As shown in FIG. 3, the database 140 contains, in an associated manner, the names of image capture locations (e.g., “a location A”) to identify a location where an image was captured, the names of image files, and image capture location information indicating the image capture locations. It should be noted that as long as a location where an image was captured can be identified, an identifiable ID may be used for example instead of the name of the image capture location. Moreover, as long as an image capture location and an image captured at the image capture location are associated in the data contained in the database 140, the name of the image capture location is not an essential element.

It should be noted that image files indicated by the names of the image files may be contained in the database 140 or outside the database 140. When the image files are contained outside the database 140, the controller 110 can read an image file indicated by the name of the image file from an area containing the image files outside the database 140 by specifying the name of the image file.

The image capture location information indicates an image capture location. The location information typically indicates a longitude and a latitude.

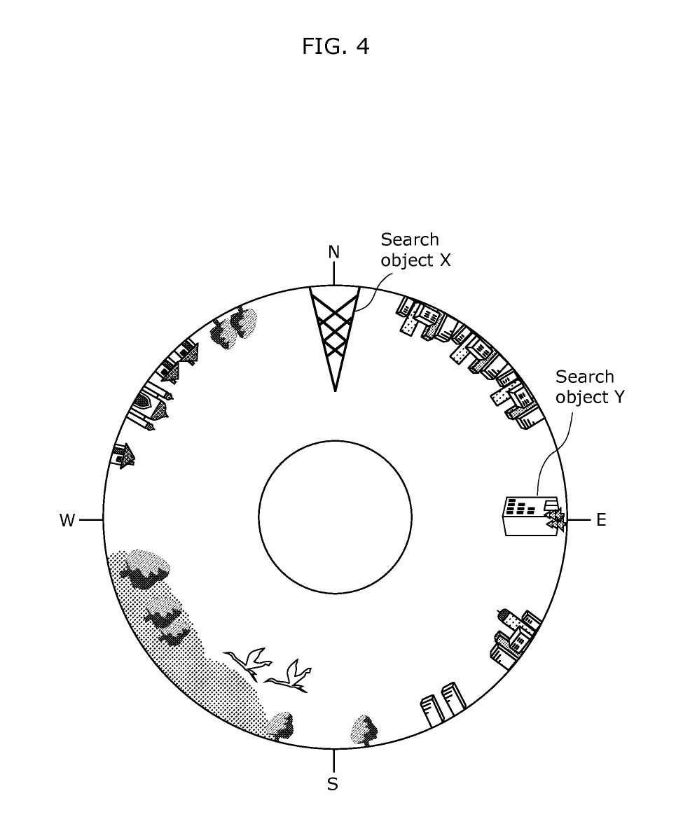

FIG. 4 illustrates an example of an image represented by image data contained in an image file. FIG. 4 is an image captured at the image capture location A. Images captured at each image capture location form an omnidirectional image. As shown in FIG. 4, an omnidirectional image is a doughnut-shaped image. The periphery of this image corresponds to the horizon and the hollow in the center of the doughnut-shaped image corresponds to the direction toward the sky.

The omnidirectional image is associated with directions when images that form the omnidirectional image were captured. A direction from an image capture location toward a search object and a portion of the omnidirectional image are associated. In other words, since the omnidirectional image is associated with directions, it is clear that an image captured from a particular direction at an image capture location corresponds to which portion of the omnidirectional image captured at the image capture location. For example, since the search object X is located to the north of the image capture location A, an image portion corresponding to the north direction in the omnidirectional image captured at the image capture location A shown by FIG. 4 is an image showing the search object X. Moreover, since the search object Y is located to the east of the image capture location A, an image portion corresponding to the east direction in the omnidirectional image captured at the image capture location A shown by FIG. 4 is an image showing the search object X. Moreover, since the image capture location A is closer to the search object X than to the search object Y, the image of the search object X is larger than the image of search object Y.

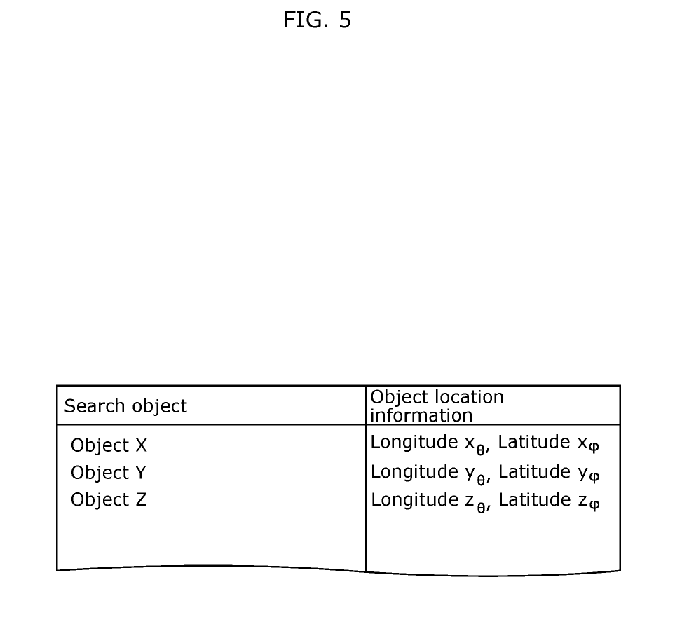

As a storage, the memory 150 prestores object information in which identification information and object location information are associated. For example, as shown in FIG. 5, the memory 150 stores, in an associated manner, the identification information (e.g., “object X”) to identify a search object and object location information indicating the location of the search object. Thus, the object information includes the identification information for identifying the search object and the object location information indicating the location of the search object. It should be noted that FIG. 5 is a schematic view of a configuration of object information used by the server 100 according to the first embodiment.

The reception unit 120 receives identification information for identifying the search object from the terminal computer 300 through the network 200. The information obtainment unit 111 obtains object location information indicating the location of the search object identified by the identification information, from object information stored in the memory 150, based on the identification information received by the reception unit 120. For example, when receiving identification information “object X”, the reception unit 120 searches the object information which is a list stored in the memory 150 (cf. FIG. 5) for the identification information “object X”, and reads information “longitude x_{θ} and latitude x_{φ}” which is the object location information associated with the identification information.

The search unit 112 searches images contained in the database 140 for at least one image associated with image capture location information indicating a location within a predetermined distance from a search object, based on the object location information obtained by the information obtainment unit 111 and the image capture location information contained in the database 140. For example, the search unit 112 searches for images captured at the image capture locations A to D which are located within a predetermined distance from “longitude x_{θ} and latitude x_{φ}” (in the circle defined by the broken line in FIG. 2), based on the object location information “longitude x_{θ} and latitude x_{φ}” obtained by the information obtainment unit 111 and the image capture location information contained in the database 140.

In the first embodiment, the search unit 112 identifies the distance between the location of a search object and an image capture location, based on the object location information on the search object obtained by the information obtainment unit 111 and the image capture location information contained in the database 140. The search unit 112 then searches image data contained in the database for data of at least one image, based on the identified distance.

More specifically, the search unit 112 can obtain the object location information on the search object and the image capture location information on image capture locations. Therefore, for each image capture location, the search unit 112 can calculate a distance from the search object to each image capture location. For example, it is possible to extract image capture locations within a predetermined distance, based on the distances calculated for the image capture locations. The search unit 112 then reads image files respectively associated with the extracted image capture locations.

The transmission unit 130 transmits the image files searched for by the search unit 112 to the terminal computer 300.

The network 200 is, for example, LAN or the Internet.

The terminal computer 300 is a normal personal computer. The terminal computer 300 includes a CPU 310, a reception unit 320, a transmission unit 330, an input unit 340, and a monitor 350.

The input unit 340 is an operation means such as a keyboard, a mouse, and a touch panel. Following operation by a user, the input unit 340 receives identification information for identifying a search object. The identification information received by the input unit 340 is transmitted to the reception unit 120 through the CPU 310, the transmission unit 330, and the network 200.

An image transmitted from the server 100 is processed at the CPU 310 and displayed on the monitor 350. Image processing at the CPU 310 includes extension. The CPU 310 includes a direction identifying unit 313 and an image clipping unit 314.

The direction identifying unit 313 identifies an object direction in which a search object appears in an image searched for by the search unit 112. The direction identifying unit 313 identifies a direction from an image capture location toward the location of the search object as the object direction, based on the object location information obtained by the information obtainment unit 111 of the server 100 and the image capture location information.

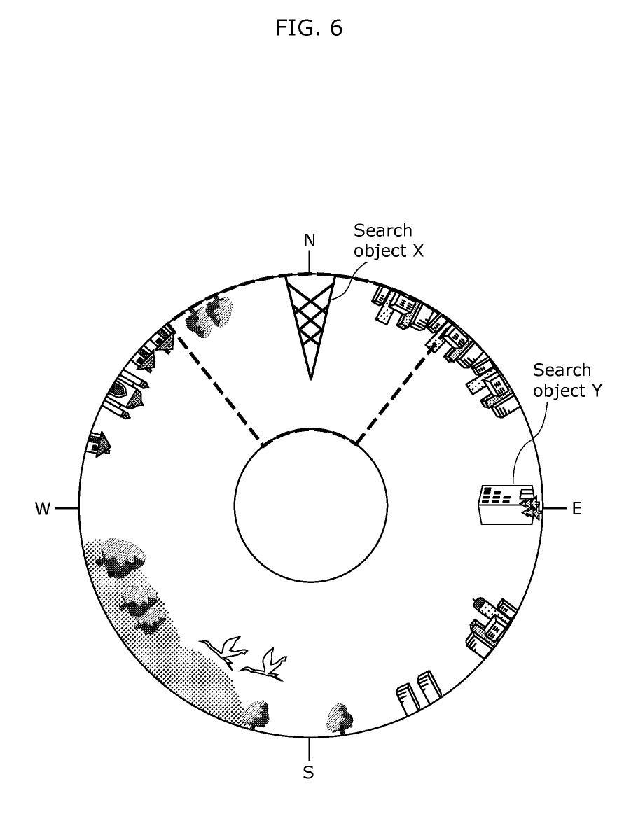

The image clipping unit 314 clips a portion including the object direction from an image searched for by the search unit 112, based on the object direction identified by the direction identifying unit 313. More specifically, as shown in FIG. 6, the image clipping unit 314 clips a fan-shaped portion (portion surrounded by the broken line in FIG. 6) from the doughnut-shaped image, as one of the image processing steps at the CPU 310. The fan-shaped portion centers the object direction identified by the direction identifying unit 313 and has a predetermined angle of view (e.g., 80 degrees). The clopped image is then transformed into a rectangular-shaped image. Such image processing is hereinafter referred to as “clip processing”. Thus, the user can recognize an omnidirectional image as a normal image. It should be noted that FIG. 6 is a schematic view illustrating a portion to be clipped from the omnidirectional image.

The clip processing by the CPU 310 and the display processing for the monitor 350 may be performed by activating software (a software program) preinstalled in the terminal computer 300 or by activating software (a software program) temporarily provided from the server 100.

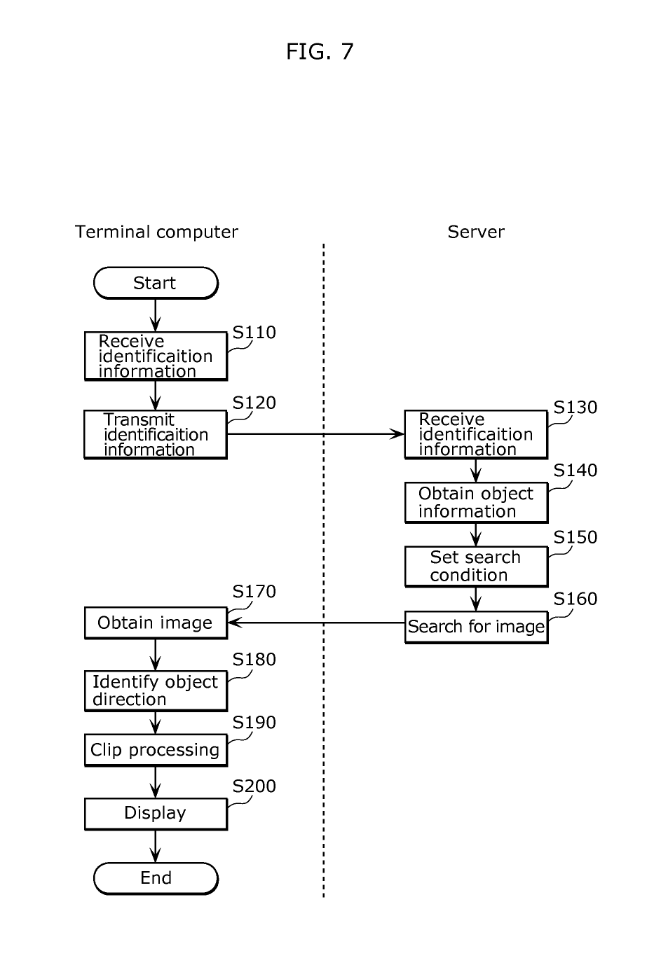

With reference to the flowchart in FIG. 7, the following describes a procedure in which using a system configured as above, an image of a desired search object is searched for and the image is displayed on the monitor 350 of the terminal computer 300. It should be noted that FIG. 7 is a flowchart illustrating the steps of the image search processing in the first embodiment.

A user performs an operation to identify a search object for the input unit 340. At this time, the terminal computer 300 may display a map as shown in FIG. 2 on the monitor 350, and identify a search object by the user specifying a point on the displayed map. The input unit 340 receives identification information following user operation, and transmits the received identification information to the CPU 310 (S110). The CPU 310 transmits the identification information received from the input unit 340 to the server 100 through the transmission unit 330 and the network 200 (S120). Here, the names of search objects, identification IDs each indicating a search object, and the addresses of the search objects are examples of identification information. However, the identification information is not limited to these examples, but any information is acceptable as long as it can identify a search object.

When the reception unit 120 receives identification information from the terminal computer 300 (S130), the information obtainment unit 111 obtains, from object information contained in the memory 150, object location information indicating the location of a search object identified based on the identification information received from the reception unit 120 (S140).

The search unit 112 then receives the object location information from the information obtainment unit 111, and sets a search condition for image search based on the received object location information (S150). In the first embodiment, a condition of within a predetermined distance is set as a search condition using the object location information in the object information shown in FIG. 5.

Using the set search condition, the search unit 112 then searches the images contained in the database 140 for images satisfying the search condition (S160).

In other words, in the steps S150 and S160, the search unit 112 searches images contained in the database 140 for at least one image associated with image capture location information indicating a location within a predetermined distance from the location of a search object, based on the object location information obtained by the information obtainment unit 111 and the image capture location information contained in the database 140.

The following describes an example of processing from steps S130 to S160 with reference to FIG. 2. When, as a search condition, the predetermined distance is a distance within 100 m from the search object X (longitude x_{θ} and latitude x_{φ}), the database 140 compares the object location information “longitude x_{θ} and latitude x_{φ}” with the image capture location information contained in the database 140 to search for image capture locations within 100 m from the location “longitude x_{θ} and latitude x_{φ}”. When four locations “longitude a_{θ} and latitude a_{φ}, “longitude b_{θ} and latitude b_{φ}”, “longitude c_{θ} and latitude c_{φ}”, and “longitude d_{θ} and latitude d_{φ}” satisfy the search condition, the search unit 112 reads “fi1e0001”, “fi1e0002”, “fi1e0003”, and “fi1e0004” that are the respective names of image files for the location A, the location B, the location C, and the location D.

The search unit 112 reads image files indicated by the names of image files based on the read names of the image files, and transmits the read image files to the terminal computer 300 through the transmission unit 130. At this time, the search unit 112 transmits image capture location information associated with the image files and object location information on the search object together with the image files to the terminal computer 300 through the transmission unit 130. It should be noted that when there are several searched image files, the image capture location information includes several image capture location information items each associated with an image file and the image capture location information items are transmitted.

The CPU 310 receives an image file, image capture location information (item) associated with each image file, and object location information on the search object from the server 100 through the reception unit 320, and obtains an image contained in each image file (S170). In other words, an image associated with the image capture location information indicating an image capture location is obtained in the step S170 as the image obtainment step.

At the CPU 310, the direction identifying unit 313 identifies an object direction in the image obtained by the step S170 that is the image obtainment step (S180). In the object direction, the search object appears. Here, the direction identifying unit 313 identifies a direction from an image capture location toward the location of a search object as the object direction, based on the object location information obtained by the information obtainment unit 111 of the server 100 and the image capture location information. For example, when the image file “file0001” is searched for regarding the search object X and obtained from the server 100, the direction identifying unit 313 identifies that the direction from the image capture location A toward the search object X (object direction) is the north direction, based on the object location information on the search object X (longitude xθ and latitude xφ) and the image capture location information which indicates the location where the image associated with the image file “fi1e0001” was captured.

Based on the object direction identified by the step S180 that is a direction identifying step, the image clipping unit 314 clips a portion including the object direction from the image obtained at the step S170 (S190). The following describes more details with reference to FIG. 6. Since the direction identifying unit 313 identifies that the search object X is located in the north direction in the image, the image clipping unit 314 recognizes, as a clipping area, a fan-shaped portion (portion surrounded by a broken line) that is an area centering on the north direction of the image and having a predetermined angle of view, and clips the clipping area from the image. An image clipping unit 114 transforms the clipped fan-shaped image into a rectangular-shaped image and then into a format for transmission before displaying the processed image on the monitor 350 (S200).

It should be noted that when there are several images after image processing such as extension processing and clip processing, various aspects can be considered when these images are displayed on the monitor 350. For example, it is also possible to reduce in size the images obtained as a result of the image processing performed at the steps S180 to S200 in the terminal computer 300 and to list the images reduced in size. Moreover, it is also possible to determine the best shot from images based on some criteria and display only the images satisfying the criteria. Moreover, it is possible to display a slid show of the images. In this case, various orders of the slides can be considered. For example, there is an order of slides in accordance with a specific route on a map.

According to the server 100 of the first embodiment, the search unit 112 searches images contained in the database 140 for at least one image showing a search object, based on object location information obtained by the information obtainment unit 111 and image capture location information. Therefore, a user can obtain an image showing the search object, for example, only by specifying the search object.

Moreover, according to the server 100 of the first embodiment, the memory 150 prestores object information in which the identification information for identifying the search object and the object location information are associated. Since the server 100 prestores the detailed information on the search object, the user can obtain an image showing the desired search object only by transmitting to the server 100 the identification information for identifying the search object.

Moreover, according to the server 100 of the first embodiment, the search unit 112 searches images contained in the database 140 for at least one image associated with image capture location information indicating a location within a predetermined distance. Therefore, since image search is performed after narrowing down images, processing burden of the server 100 required for the image search can be reduced.

Moreover, according to the image search system 1 of the first embodiment, the image clipping unit 314 clips a portion including the search object from the image obtained as a result of the search by the search unit 112, based on object direction in which the object appears and which is identified by the direction identifying unit 313. Therefore, the user can obtain an image corresponding to a clipped portion showing the search object. In other words, it is possible to reduce burden of the user to find out the portion showing the search object from the searched image.

Moreover, according to the image search system 1 of the first embodiment, since the direction identifying unit 313 identifies, as object direction, the direction from an image capture location toward the location of a search object, a direction to be clipped can be automatically determined.

### Embodiment 2

In the second embodiment, the memory 150 contains, in an associated manner, the object information according to the first embodiment and directional information indicating a predetermined direction from the location of the search object toward a location where a predetermined image of the search object can be viewed. This means that while images captured from various directions are searched for in the first embodiment, images captured from a desired direction are searched for in the second embodiment.

As a configuration of the server 100 according to the second embodiment is the same as that of the server 100 shown in FIG. 1, the explanation will be omitted here. Differences from the first embodiment are in that (i) directional information is added to the object information contained in the memory 150, (ii) the information obtainment unit reads the directional information as well as object location information, and (iii) the search unit 112 searches for images using the directional information as well as location information.

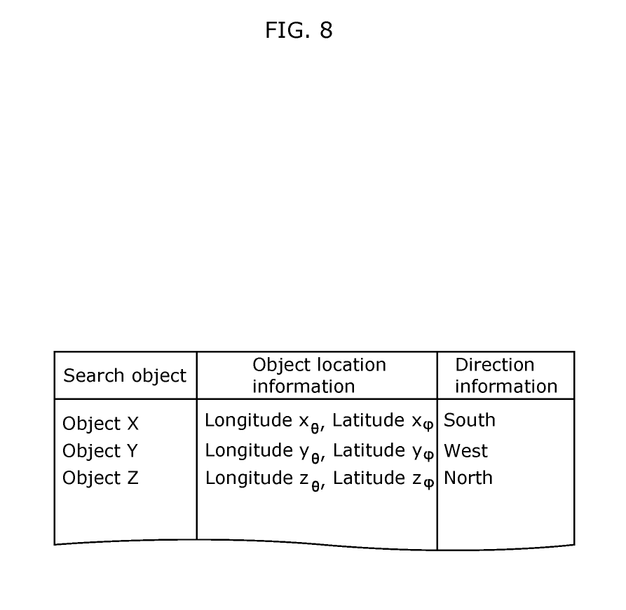

FIG. 8 is a schematic view illustrating a configuration of object information used by the server 100 according to the second embodiment. The object information is stored in association with directional information in addition to identification information for identifying a search object and object location information. The directional information indicates a predetermined direction from the location of the search object toward a location where a predetermined image of the search object can be viewed. In other words, the directional information indicates a direction in which the best image of the search object was captured. With reference to a specific example, in FIG. 8, the search object X is associated with directional information “south” as the directional information. This means that an image of the search object X captured from the south side is required. In other words, the directional information indicates a suitable direction when capturing an associated search object. In other words, the directional information identifies an image when a user looks at the search object from a predetermined direction from where it is easier for the user to recognize as the search object. For instance, the directional information is information for identifying an image of the “front” of the search object, which is a distinctive image of a building, for example. Therefore, when the user captures the search object X from the south side, the captured image includes an image easily recognized as the search object X. Moreover, it is understood that the “front” of the search object X faces the south.

The following describes image search processing of the server 100 according to the second embodiment with reference to the flowchart shown in FIG. 7.

Until the reception unit 120 receives identification information from the terminal computer 300 (S130), steps are the same as those described in the first embodiment. Therefore, the explanation will begin with the next processing (S140).

After the reception unit 120 receives the identification information from the terminal computer 300 in the step S130, the information obtainment unit 111 obtains, from object information stored in the memory 150, object location information indicating the location of a search object identified based on the identification information received by the reception unit 120 (S140). Here, the information obtainment unit 111 further obtains directional information indicating a predetermined direction from the location of the search object toward a location where a predetermined image of the search object can be viewed.

The search unit 112 receives the object location information and the directional information from the information obtainment unit 111, and sets a search condition for image search based on the received object location information and directional information (S150). In the second embodiment, a condition that an image capture location is in an area within a predetermined distance from the location indicated by the object location information and is included in an area corresponding to a direction indicated by the directional information is set as a search condition, by using the object location information and the directional information in the object information shown in FIG. 8. For example, a search condition for the search object X is a condition that an image capture location is within a predetermined distance from the search object X and the image capture location is in the south direction from the search object X.

The search unit 112 then searches images contained in the database 140 for images satisfying the search condition, using the set search condition (S160).

In other words, in the steps S150 and S160, the search unit 112 searches images contained in the database 140 for one or more image data items associated with image capture location information indicating a location on a predetermined direction side indicated by the directional information from the location of the search object, based on the directional information obtained by the information obtainment unit 111 and the image capture location information contained in the database 140.

The following describes an example of the processing from the steps S130 to S160 with reference to FIG. 2. The image capture locations A to D are extracted which are within 100 m from the search object X (longitude xθ and latitude xφ). Here, 100 m is a distance predetermined as a search condition. Then, the image capture location A is extracted which is located in the south direction from the search object X. The search unit 112 then reads the name of the image file “file0001” corresponding to the extracted image capture location A. Finally, the search unit 112 reads an image file based on the read name of the image file, and transmits the read image file to the terminal computer 300 through the transmission unit 130.

The processing performed by the terminal computer 300 in steps S170 to S200 after the step S160 is the same as that in the first embodiment. Therefore, the explanation will be omitted here.

It should be noted that the step S180 performed by the direction identifying unit 313 may be performed in a manner similar to the first embodiment or may be performed using the directional information. In other words, the direction identifying unit 313 may identify the predetermined direction indicated by the directional information as the object direction. For example, if the directional information is available, at a point when the image capture location A is extracted, it is apparent that the image capture location A is located in the south direction from the search object X. Therefore, it is obvious that the search object X appears in an area corresponding to the north direction in the omnidirectional image captured at the image capture location A. Therefore, when the direction identifying unit 313 identifies the north direction in the omnidirectional image captured at the image capture location A as the object direction, the image clipping unit 314 can clip the image covering the direction in the subsequent step S190. Thus, it is possible to reduce the burden of the direction identifying unit 313 to perform arithmetic processing for indentifying a clipping area.

According to the server 100 of the second embodiment, the search unit 112 searches images contained in the database 140 for at least one image associated with image capture location information indicating a location in a predetermined direction from a search object indicated by directional information, based on the directional information indicating the predetermined direction and the image capture location information. Therefore, since image search is performed after narrowing down images based on the directional information, processing burden required for the image search can be reduced in the server 100.

It should be noted that in the second embodiment, the server 100 performs both of image search processing based on the location information and image search processing based on the directional information. However, the server 100 and the terminal computer 300 may perform the image search processing. For example, the server 100 may perform the image search processing based on the object location information and the image capture location information while the terminal computer 300 may perform the image search processing based on the directional information. In this case, the server 100 does not have to transmit images to the terminal computer 300 before the terminal computer 300 searches. As long as at least the server 100 transmits information required for the image search processing such as image capture location information, the images do not have to be transmitted. The server 100 only has to transmit images after receiving a result of the search by the terminal computer 300. By so doing, the volume of data to be transmitted from the server 100 to the terminal computer 300 can be reduced. Moreover, the server may transmit a program for performing the image search processing based on the directional information at the terminal computer 300.

It should be noted that in the second embodiment, the directional information indicates a predetermined direction associated with a search object. However, the directional information is not limited to indicate such a direction but may indicate a direction obtained as a result of estimation by a predetermined algorithm. For example, the information obtainment unit may obtain, as the object information, a result obtained using an algorithm that, for example, estimates the direction of the “front” of the search object based on, for example, a positional relationship between the search object and a road along with the search object and the width of the road.

### Embodiment 3

A server performs clip processing in the third embodiment.

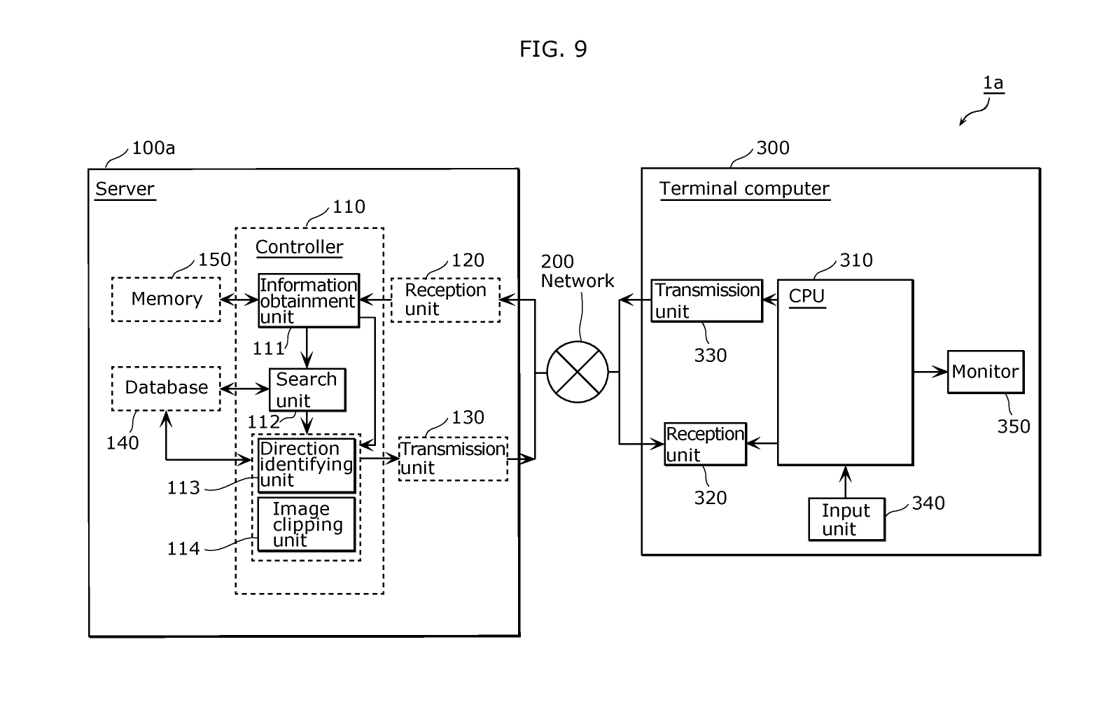

FIG. 9 is a block diagram illustrating a configuration of an image search system including a server 100a according to the third embodiment. The configuration difference between a server 100a in the third embodiment and the server 100 in the first embodiment is in that the server 100a further includes a direction identifying unit 113 and an image clipping unit 114.

The direction identifying unit 113 identifies an object direction in which a search object appears in an image searched for by the search unit 112. More specifically, the direction identifying unit 113 identifies, as an object direction, a direction from an image capture location toward the search object, based on object location information obtained by an information obtainment unit and image capture location information. The image clipping unit 114 clips a portion including the object direction from the image, based on the object direction identified by the direction identifying unit 113.

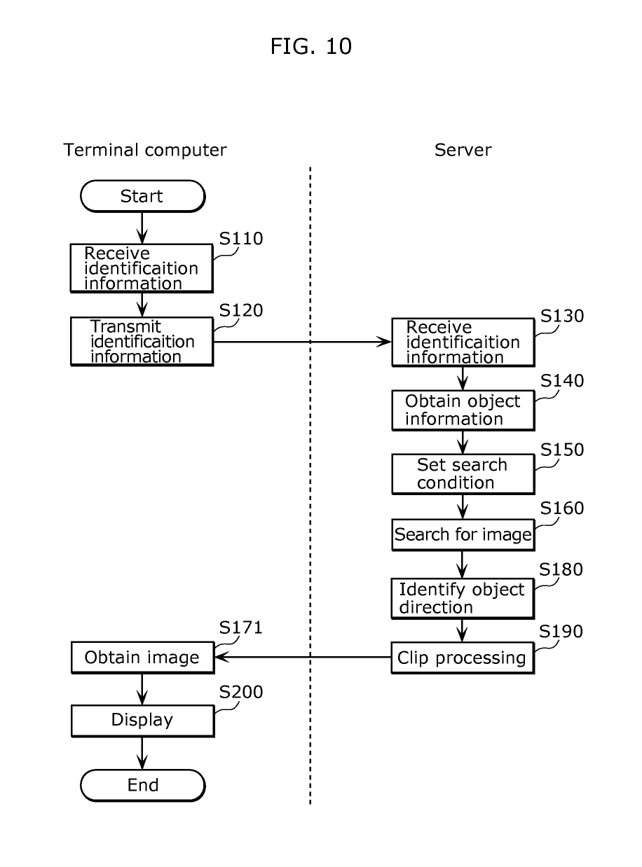

Moreover, FIG. 10 is a flowchart illustrating the steps of image search processing in the third embodiment. A difference from FIG. 7 illustrating the image search processing in the first embodiment is in that the processing to identify an object direction (S180) and the clip processing (S190) are not performed by the terminal computer 300 but performed by the server 100a. Moreover, another difference is in that the terminal computer 300 obtains images after the clip processing is performed in step S171. The processing excluding the step S171 is the same image search processing as the first embodiment. Therefore, the explanation will be omitted here.

In an image search system la according to the third embodiment, the server 100a performs the clip processing. Thus, processing burden in the terminal computer 300 can be reduced. Moreover, since the clip processing of the server 100a can be also automatically performed, processing efficiency can be improved.

### Embodiment 4

In the first embodiment, regardless of whether or not an image of a search object that a user desires is in fact included, image search is performed based on the positional relationship between an image capture location and the search object. When the search object is failed to be captured due to the weather conditions when the image is captured or an obstacle, images to be searched for may not show the search object. Here, in the fourth embodiment, image search processing is performed not only using a search condition of the positional relationship between the search object desired by the user and an image capture location, but also using a condition that whether or not an image of the search object has been successfully captured.

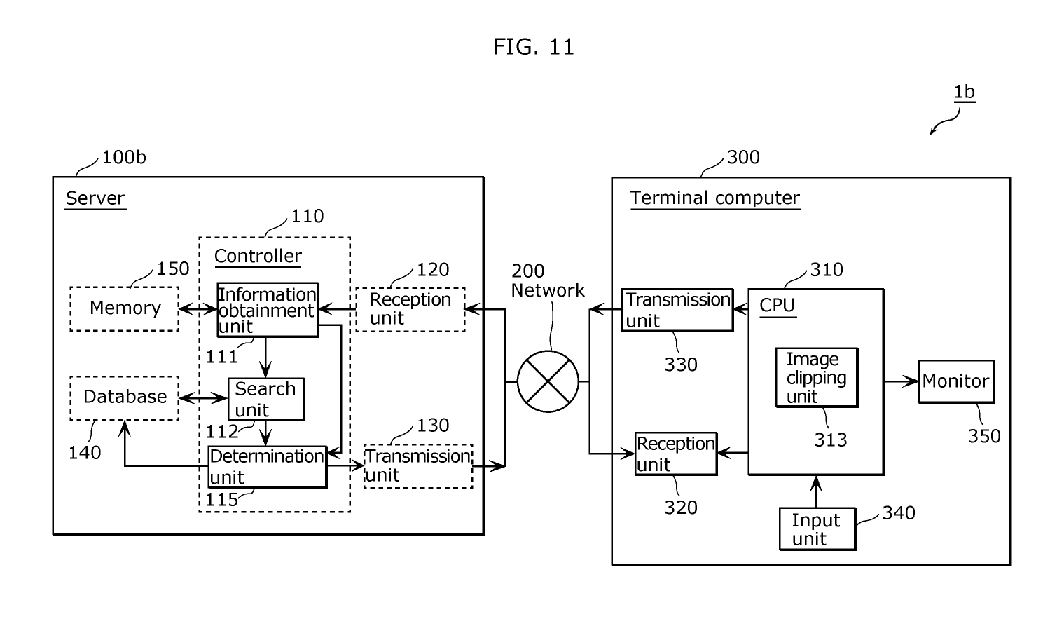

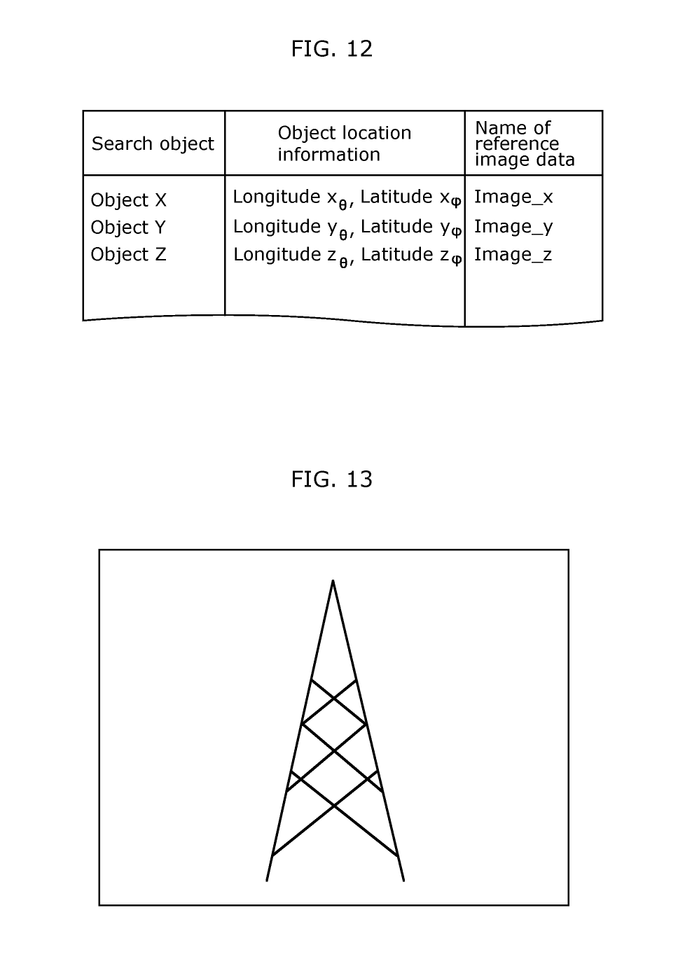

FIG. 11 is a block diagram illustrating a configuration of an image search system lb including a server 100b according to the fourth embodiment. FIG. 12 is a schematic view illustrating a configuration of object information used by the server 100b according to the fourth embodiment. The configuration difference between a server 100b in the fourth embodiment and the server 100 in the first embodiment is in that the server 100b further includes a determination unit 115. Moreover, in the fourth embodiment, object information is stored in a memory 150 and includes, in an associated manner, the object information according to the first embodiment and a reference image indicating an image of a portion of the search object.

Moreover, in the server 100b according to the fourth embodiment, the information obtainment unit 111 not only obtains object location information from the memory 150, but also obtains the reference image indicating the image of a portion of the search object.

The determination unit 115 determines whether or not an image searched for by the search unit 112 includes the reference image, based on the reference image obtained by the information obtainment unit 111.

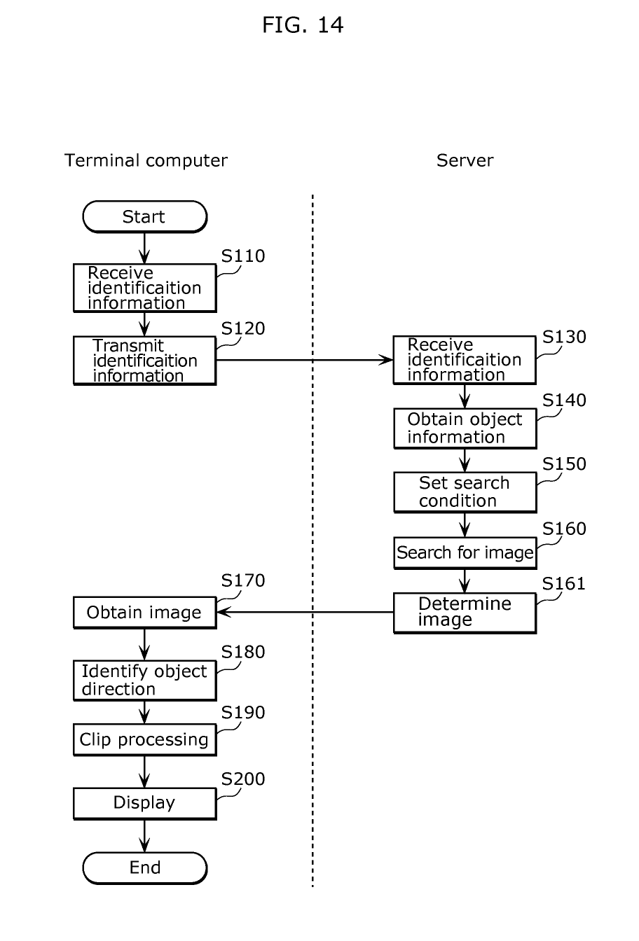

The following describes image search processing by the server 100b according to the fourth embodiment with reference to the flowchart shown in FIG. 14. FIG. 14 is a flowchart illustrating the steps of the image search processing in the fourth embodiment. Until the reception unit 120 receives identification information from the terminal computer 300 (S130), steps are the same as those described in the first embodiment. Therefore, the explanation will begin with the next processing (S140).

After the reception unit 120 receives the identification information from the terminal computer 300 in the step S130, the information obtainment unit 111 obtains, from object information stored in the memory 150, object location information indicating the location of a search object identified based on the identification information received by the reception unit 120 (S140). At this time, the information obtainment unit 111 reads the object location information on the search object and the name of reference image data from the memory 150, as object information. The information obtainment unit 111 further reads a reference image from the memory 150 or another storage unit, based on the read name of the reference image data. Here, the reference image is an image of a portion of the search object in association with the name of the reference image data. For example, a reference image represented by the name of a reference image data “Image_x” is image data representing an image of the search object X (cf. FIG. 13). It should be noted that FIG. 13 is an example of the image of the search object X.

The search unit 112 receives the object location information from the information obtainment unit 111, and sets a search condition for image search based on the received object location information (150). In the fourth embodiment, in a similar manner to the first embodiment, a condition of within a predetermined distance is set as a search condition using object location information in the object information shown in FIG. 12.

The search unit 112 then searches images contained in the database 140 for images satisfying the search condition, using the set search condition (S160). The determination unit 115 determines whether or not an image searched for by the search unit 112 includes a reference image, based on the reference image obtained by the information obtainment unit 111 (S161). Here, the determination unit 115 transmits an image determined to include the reference image to the terminal computer 300 through the transmission unit 130. It should be noted that the determination unit 115 does not transmit an image determined not to include the reference image to the terminal computer 300 through the transmission unit 130.

The subsequent processing steps at the terminal computer 300 are similar to those in the first embodiment.

According to the image search system 1b of the fourth embodiment, the determination unit 115 automatically determines whether or not the images extracted by the search unit 112 include an image of the search object. Therefore, an image showing the good image of the search object can be easily obtained.

### Embodiment 5

In the fifth embodiment, a terminal computer performs image search processing.

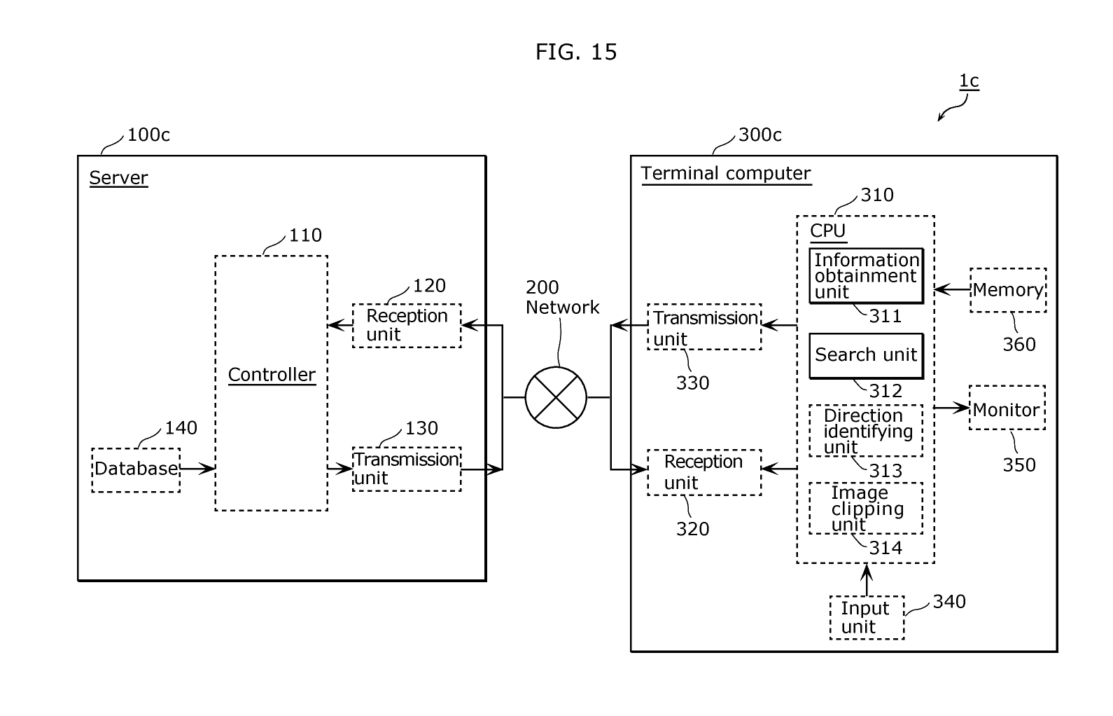

FIG. 15 is a block diagram illustrating a configuration of an image search system 1c including a terminal computer 300c according to the fifth embodiment. A configuration difference between a server 100c in the fifth embodiment and the server 100 in the first embodiment is in that the server 100c does not include the information obtainment unit 111 and the search unit 112 for performing the image search processing. Moreover, another configuration difference between the terminal computer 300c in the fourth embodiment and the terminal computer 300 in the first embodiment is in that the terminal computer 300c further includes a memory 360 and a CPU 310 including an information obtainment unit 311 and a search unit 312. It should be noted that the terminal computer 300c as a terminal device is a terminal device for searching a database 140 for images. The database 140 contains the image capture location information indicating an image capture location and the image captured at the image capture location in an associated manner. The terminal computer 300c only has to include the information obtainment unit 311 and the search unit 312, and a memory 360 is not an essential element.

The information obtainment unit 311 obtains object location information indicating the location of a search object. It should be noted that in this case, the information obtainment unit 311 obtains the object location information indicating the location of the search object identified by identification information, from the object information stored in the memory 360, based on the identification information for identifying the search object received by the input unit 340.

The search unit 312 searches images contained in the database 140 for at least one image showing the search object, based on the object location information obtained by the information obtainment unit 311 and the image capture location information contained in the database 140. It should be noted that in this case, the search unit 312 searches the images contained in the database 140 of the server 100c for the images showing the search object. For example, several images captured in a specified area (such as data of images captured within a specific administrative district) may be obtained from among the images contained in the database 140 of the server 100. In other words, when searching the images contained in the database 140, the search unit 312 narrows down to several images captured in a specified area and searches the several narrowed-down images for the images showing the search object.

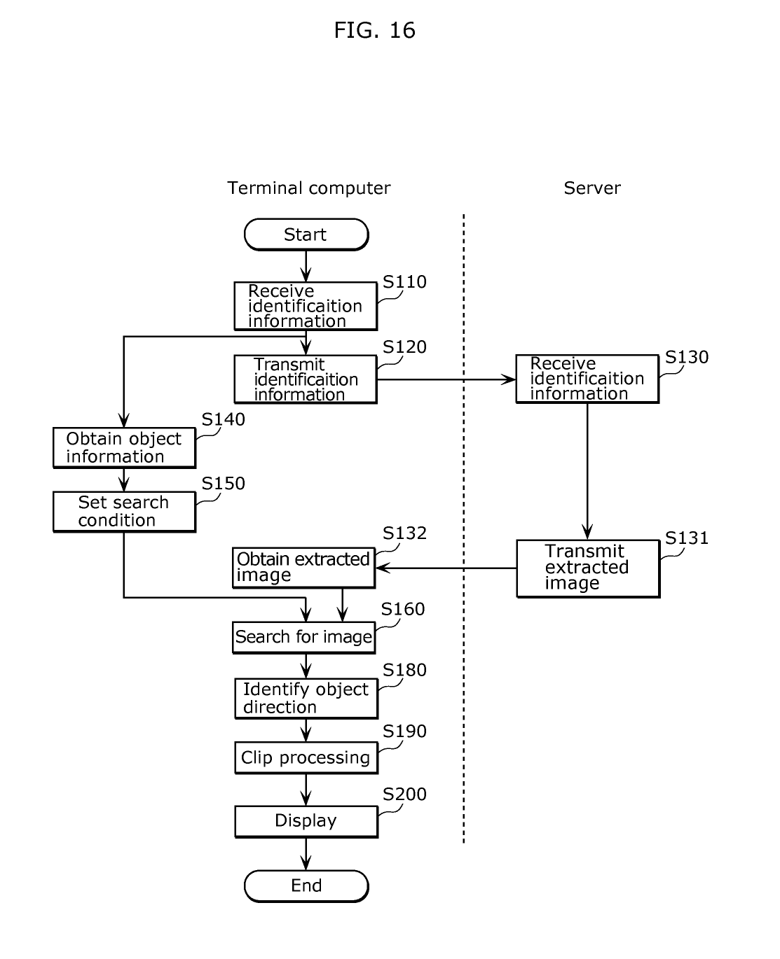

FIG. 16 is a flowchart illustrating the steps of the image search processing in the fifth embodiment.

In a similar manner to the first embodiment, the input unit 340 receives identification information following operation by a user, and transmits the received identification information to the CPU 310 (S110). The CPU 310 transmits the identification information received from the input unit 340 to the server 100c through a transmission unit 330 and a network 200 (S120).

When the reception unit 120 receives the identification information from the terminal computer 300c (S130), a controller 110 of the server 100c extracts several images captured in a specified area from the images contained in the database 140 based on a specified area derived from the received identification information, and transmits the extracted several images (extracted images) to the terminal computer 300c (S131).

The CPU 310 receives the extracted images from the server 100c through the reception unit 320 (S132).

In the CPU 310, while the step S120 is performed, the information obtainment unit 311 obtains, from the object information stored in the memory 360, the object location information indicating the location of the search object identified based on the identification information received from the input unit 340 (S140).

The search unit 312 receives the object location information from the information obtainment unit 311, and sets a search condition for image search based on the received object location information (S150). The search unit 312 searches extracted images received from the server 100c for images satisfying the search condition, using the set search condition (S160). In the CPU 310, the direction identifying unit 313 identifies an object direction in which the search object appears in an image obtained as a result of the search in the step S160 (S180). After the step S180, processing steps are performed in a similar manner to the steps S190 and S200 of the image search processing in the first embodiment, and the image search processing in the fifth embodiment ends.

Thus, the terminal computer 300c includes the information obtainment unit 311 and the search unit 312. Therefore, the terminal computer 300c itself can perform the image search processing. This means that as long as the image search processing based on the object information is achieved by a system including a server and a terminal computer, it may be achieved by the server or the terminal computer.

It should be noted that after the image search processing, the direction identifying unit 313 and the image clipping unit 314 can perform the image processing as mentioned above in the terminal computer 300c. However, it is not essential for the terminal computer 300 to include the direction identifying unit 313 and the image clipping unit 314. Moreover, the memory 360 prestoring the object information does not have to be provided in the terminal computer 300c, but may be provided in the server 100c or an external device connected to the network 200. Moreover, the database 140 does not have to be provided in the server 100c, but may be provided in the terminal computer 300c.

### Other Embodiment

The first to fifth embodiments of the present disclosure described above are exemplary. However, the present disclosure is not limited to these embodiments but is applicable to appropriately modified embodiments. Moreover, a new embodiment can be made by combining invention elements described in the first to fifth embodiments.

Here, the following describes other embodiments of the present disclosure all together.

The present description recites image search processing based on object information on a search object. Moreover, as an example of the image search processing, image search processing based on the object location information on the search object and image search processing based on directional information on the search object were recited. Moreover, image clip processing was recited and, in particular, clip processing based on the object location information on the search object and clip information based on the directional information on the search object were detailed. Moreover, determination of the quality of an image based on a reference image was also recited. In the actual embodiments, these processing steps are appropriately selected and combined.

Moreover, combined processing of the steps may be achieved as a whole system, and may be performed by a server or a terminal computer.

### Modification 1

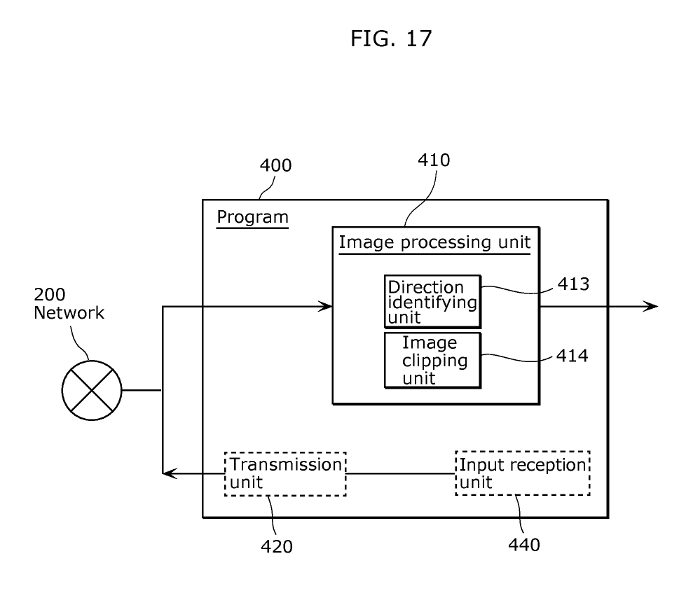

Moreover, the terminal computer 300 according to the first and second embodiments performs the steps S110, S120, S170, S180, S190, and S200 by activating a program preinstalled in the terminal computer 300. However, the terminal computer 300 may perform these steps not only by activating the preinstalled software, but also by activating a program provided by the server 100. In this case, a program 400 provided by the server 100, for example, includes an image processing unit 410, a transmission unit 420, and an input reception unit 440 as shown in FIG. 17. It should be noted that FIG. 17 is a block diagram illustrating a configuration of a program 400 activated by the terminal computer 300 according to the first modification.

In other words, this program 400 causes the terminal computer 300 to execute an image processing method including (i) an image obtainment step for obtaining an image associated with image capture location information indicating an image capture location, (ii) a direction identifying step for identifying an object direction in which the search object appears in the image obtained in the image obtainment step, and (iii) an image clipping step for clipping a portion including a object direction from the image based on the object direction identified in the direction identifying step.

In FIG. 17, the input reception unit 440 causes the terminal computer 300 to receive input of identification information for identifying a search object.

The transmission unit 420 causes the terminal computer 300 to transmit to the server 100, the identification information received by the input reception unit 440.

The image processing unit 410 includes a direction identifying unit 413 and an image clipping unit 414. In other words, the program 400 performs the processing of the direction identifying unit 313 and the image clipping unit 314 which was described in the first embodiment. The terminal computer 300 is caused to perform the image processing (the steps S180 and S190) on images searched for by the search unit 112 of the server 100 and received from the server 100 as the search result.

It should be noted that a server for transmitting the program 400 to the terminal computer 300 may be the server 100 according to the first embodiment or a server different from the server 100. In other words, a server for performing image search and a server for transmitting the program 400 for performing the image processing to the terminal computer 300 may be physically the same server or different servers. Even when several groups of servers are used, as long as processing steps are the same processing steps in the present disclosure, these groups of servers are servers or systems that employ the present disclosure. When the several servers are used, the terminal computer 300 may access the server 100 and following the access, the server 100 may instruct another server to transmit the program 400 to the terminal computer 300, for example. Moreover, for example, the terminal computer 300 may access another server so that the server transmits a program similar to the program 400. In this case, the program instructs the terminal computer 300 to access the server 100 and transmit input information (here, identification information) to the server 100. In this way, even when the several servers are used, a user does not feel inconvenience.

Likewise, the server 100 for performing processing for obtaining object information and image search processing according to the first embodiment may be one server or may be formed of several servers.

### Modification 2

Moreover, in the program 400 installed in the image search systems 1, 1a, 1b, and 1c and the terminal computer 300 according to the first to fifth embodiments, a user does not input the directional information indicating a direction in which the best image of the search object was captured. However, the user may input in advance identification information on the search object and the directional information to the input unit 340 and the input reception unit 440 of the terminal computer 300. In this case, the image clipping units 314 and 414 of the terminal computer 300 clip a portion of an image searched for by the search unit 112, based on directional information received by the input unit 340 or the input reception unit 440.

Thus, image search is performed based on information inputted by the user instead of using object information prestored in the memory 150. Therefore, it becomes easier for the user to search for images meeting user's preference. For example, although generally speaking, the “front” of the search object X faces the south direction, the user may capture a different face of the search object X, depending on the user's preference. In such a case, this is convenient for the user when searching for an image showing a face of the user's preference.

Moreover, part of the object information may be searched for from information stored in the memory 150, and the remaining other part may be based on every input from the user. For example, while information stored in the memory 150 is searched for location information, directional information may be based on every input from the user.

### Modification 3

Moreover, in the server 100, 100a, 100b, and the terminal computer 300c according to the first to fifth embodiments, the search units 112 and 312 narrow down to an area within a predetermined distance from the location of a search object indicated by object location information, based on the object location information. However, the present disclosure is not limited to narrowing down based on the location of the search object. For example, after population of database is formed by some kind of method, search may be performed based on the directional information. For example, an image database containing images captured within an administrative district is created beforehand, and image search processing may be performed on the images captured in the administrative district including the search object, based on the directional information.

### Modification 4

Moreover, in the server 100, 100a, and 100b according to the first to fourth embodiments, the information obtainment unit 111 obtains object location information indicating the location of a search object identified by identification information, from object information stored in the memory 150, based on the identification information received from the terminal computer 300. However, the object information does not have to be stored in the memory 150 in the present disclosure. For example, the object information may be stored in the terminal computer 300, and the information obtainment unit 111 may obtain the object information from the terminal computer 300 or use information inputted by a user as the object information. In this case, the information obtainment unit 111 of the server 100 does not have to search information stored in the memory 150 for the object information. Therefore, processing burden of the information obtainment unit 111 of the server 100 can be reduced.

It should be noted that “information obtainment unit for obtaining object location information indicating the location of a search object” in the present disclosure includes obtainment of object location information via the network and obtainment of the object location information by searching for the search object based on identification information. Moreover, it also includes a case where input is received from a user but not through the network and the input information is considered as the object information.

### Modification 5

Moreover, in the servers 100, 100a, 100b, or the terminal computer 300c according to the first to fifth embodiments, the search units 112 and 312 search images contained in the database 140 for at least one image associated with image capture location information indicating a location within a predetermined distance from the location of a search object. Here, the predetermined distance is a certain distance set for any search objects. However, in addition to this setting, the predetermined distance may be increased as the height of the search object increases by, for example, storing the height of the search object as the object information. When the height of the search object is greater, the search object can be recognized from a more distant location. Therefore, an image showing the search object can be effectively obtained by increasing predetermined distance as the height of the search object increases. Here, the predetermined distance is a search condition used for search by the search units 112 and 312.

### Modification 6

Moreover, in the program 400 executed by the server 100a, the terminal computer 300, or the terminal computer 300 according to the first, third and fifth embodiments, the direction identifying units 113, 313, and 411 identify object direction from the positional relationship between a search object and an image capture location, based on object location information on the search object and image capture location information on the image capture location. However, the object direction does not have to be identified using the object location information and the image capture location information, but the object direction may be identified by image processing. As an example of a specific method of imaging processing by the direction identifying unit, an image of a portion of the search object may be held in advance, and an image searched for by the search unit 112 (doughnut-shaped image) and an image of a portion of the search object may be compared to identify, as object direction, an area including the image of a portion of the search object in the searched image.

### Modification 7

Moreover, although the first to fifth embodiments assume static images, the present disclosure is not limited to the static images but may cover dynamic images. For the dynamic images, location information on an image capture location and a recording time period of a dynamic image may be associated, and this may be outputted as a search result which also indicates during which time period the dynamic image was recorded.

### Modification 8

Moreover, although doughnut-shaped omnidirectional images are to be searched in the first to fifth embodiments, but other types of images may be searched. The present disclosure is applicable to both band-shaped images and rectangular-shaped panoramic images. Moreover, as long as position and direction of an image are associated, even if the image is not an omnidirectional image, the direction identifying unit can identify the direction from an image capture location toward a search object, based on the object location information and the image capture location information, as an object direction. Therefore, the direction identifying unit can perform clip processing based on the object direction. Moreover, the present disclosure is applicable to normal images in addition to panoramic images. In this case, there is a high possibility that the clip processing is not performed. This means that when image search is performed on object information that is information on a search object, using database containing image capture location information and image data in an associated manner, the present disclosure is applicable to any images to be searched.

Moreover, in the embodiments, each structural element may be achieved by making each structural element with a special hardware, or executing a software program suitable for each structural element. A program execution unit such as CPU or a processor reads and executes a software program recorded on a recording medium such as a hard disk or a semiconductor memory so that each structural element may be achieved. Here, the following program is software that achieves the servers and others in the embodiments.

Moreover, this program may cause a computer to execute an image search method for searching for an image in a database containing image capture location information indicating an image capture location and an image captured at the image capture location in an associated manner, the method including: obtaining object location information indicating a location of a search object; and searching images contained in the database for at least one image showing the search object, based on the object location information and the image capture location information contained in the database.

Although servers according to only some exemplary embodiments of the present disclosure have been described in detail above, those skilled in the art will readily appreciate that many modifications are possible in the exemplary embodiments without materially departing from the novel teachings and advantages of the present disclosure.

### INDUSTRIAL APPLICABILITY

The present disclosure is applicable to image search devices for searching for desired image data in a database containing image capture location and image data in an associated manner. More specifically, the present disclosure is, for example, applicable to servers including an image database, terminal computers capable of image search, and potable devices such as smartphones.

1. A server for searching for an image in a database containing image capture location information indicating an image capture location and an image captured at the image capture location in an associated manner, the server comprising:
an information obtainment unit configured to obtain object location information indicating a location of a search object; and
a search unit configured to identify an area including the location of the search object, based on the object location information obtained by the information obtainment unit, and to search the database for an image captured at the image capture location within the area and including an image of the search object, based on the image capture location information contained in the database.

2. The server according to claim 1, further comprising:
a reception unit configured to receive identification information for identifying the search object; and
a storage unit configured to prestore object information in which the identification information and the object location information are associated,
wherein the information obtainment unit is configured to obtain the object location information from the object information stored in the storage unit, based on the identification information received by the reception unit, the object location information indicating the location of the search object identified by the identification information.

3. The server according to claim 1,
wherein the search unit is configured to search images contained in the database for at least one image associated with image capture location information indicating a location in an area within a predetermined distance from the location of the search object, based on the object location information obtained by the information obtainment unit and the image capture location information contained in the database.

4. The server according to claim 3,
wherein the storage unit is configured to further store a height of the search object as the object information, and
the search unit is configured to perform the search after increasing the predetermined distance as the height of the search object increases.

5. The server according to claim 1,
wherein the information obtainment unit is configured to further obtain directional information indicating a predetermined direction from the location of the search object toward a location in which a predetermined image of the search object can be viewed, and
the search unit is configured to search images contained in the database for at least one image associated with image capture location information indicating a location in a predetermined direction from the location of the search object, based on the directional information obtained by the information obtainment unit and the image capture location information contained in the database, the predetermined direction being indicated by the directional information.

6. The server according to claim 1,
wherein the information obtainment unit is configured to further obtain a reference image showing an image of a portion of the search object,
the server further comprising
a determination unit configured to determine whether or not the image searched for by the search unit includes the reference image, based on the reference image obtained by the information obtainment unit.

7. The server according to claim 1, further comprising:
a direction identifying unit configured to identify an object direction in which the search object appears in the image searched for by the search unit; and
an image clipping unit configured to clip a portion including the object direction from the image based on the object direction identified by the direction identifying unit.

8. The server according to claim 7,
wherein the direction identifying unit is configured to identify a direction from the image capture location toward the location of the search object as the object direction, based on the object location information obtained by the information obtainment unit and the image capture location information.

9. A terminal device for searching for an image in a database containing image capture location information indicating an image capture location and an image captured at the image capture location in an associated manner, which comprising:
an information obtainment unit configured to obtain object location information indicating a location of a search object; and
a search unit configured to identify an area including the location of the search object, based on the object location information obtained by the information obtainment unit, and to search the database for an image captured at the image capture location within the area, based on the image capture location information contained in the database.

10. An image search method for searching for an image in a database containing image capture location information indicating an image capture location and an image captured at the image capture location in an associated manner, the method comprising:
obtaining object location information indicating a location of a search object; and
identifying an area including the location of the search object, based on the object location information obtained in the obtaining, and searching the database for an image captured at the image capture location within the area, based on the image capture location information contained in the database.

11. A non-transitory computer-readable recording medium storing a program for causing a computer to execute the image search method according to claim 10.
